(19) United States
(12) Patent Application Publication
(10) Pub. No.: US 2004/0009777 A1
(43) Pub. Date: Jan. 15, 2004

(54) Method and an arrangement for upgrading target devices

(75) Inventors: Oskari Koskimies, Helsinki (FI); Esa Erola, Kauniainen (FI); Lioudmila Blants, Espoo (FI); Jukka-Pekka Salmenkaita, Espoo (FI); Petri Vesikivi, Espoo (FI); Eugene Young, Helsinki (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/440,055

(22) Filed: May 14, 2003

(30) Foreign Application Priority Data
May 14, 2002 (FI) FI20020904

(51) Int. Cl. H04M 1/00

(52) U.S. Cl. 455/456.1; 455/550.1

(57) ABSTRACT

The invention relates to a method and an arrangement for upgrading a target device via a wireless connection. Upgrade is executed by exploiting a wireless personal communications device (101) as a gateway between the content provider server (104) and the target device (102). A DRM scheme may be applied to said method for limiting the usage of transmitted content. The content may be encapsulated in a SMS or MMS message. A wireless personal communications device (101) capable of executing the presented method can be used e.g. as a personalization tool for downloadable sounds to be reproduced by a target device (102) such as a toy.

### CROSS-REFERENCE TO RELATED APPLICATIONS

This applications claims priority under 35 USC §119 to Finland patent application number FI 20020904 filed on May 14, 2002.

### TECHNICAL FIELD

The present invention relates to a method and an arrangement for upgrading a target device.

### BACKGROUND OF THE INVENTION

Nowadays many digital devices like MP3 players and pocket computers can be upgraded and personalized by loading new software, add-on features, feature activation keys, multimedia files including pictures, videos, music etc into the memory of the device. The related data is transferred through a data connection between a standard PC computer and said target device. Necessary upgrade information is commonly acquired from the content provider server and stored temporarily in the computer, as many service providers and product manufacturers prefer the affordable and convenient way of distributing new software and other types of data via the Internet. Sophisticated connectivity and data transmission means like integrated Ethernet cards with full-scale TCP/IP (Transmission Control Protocol/Internet Protocol) support are seldom included in the target devices as such because corresponding devices are typically designed for mass-production and the resulting number of components and manufacturing phases is typically minimized. Target devices may also lack a multipurpose user interface needed for controlling a potentially complicated upgrade process. The above-mentioned PC based upgrade approach is naturally more practical than the traditional method of updating e.g. computer software wherein a completely new software package including recently ordered optional features is sent to the customer by the product vendor or manufacturer and then installed in the target system possibly resulting in a maintenance break as well as extra delays and costs due to the shipping.

Documents US2001031652 and US2001021669 disclose an apparatus and a method for a wireless computer controlled toy system, wherein various control commands and sound data are transmitted between a computer system and a toy. These commands and sound data are used for e.g. controlling the movement of the toy, changing the toy's current state and producing the preferred sounds as an output. Additionally, the computer system itself may be controlled by the toy.

Document WO9953621 discloses a method and a system for interfacing a wireless communications device with an accessory, wherein a communications device detects an attachment of the accessory and downloads the accessory interface software from said accessory for further communication with the accessory.

Hasbro Inc. has produced a puppet, which can be personalized through a www page by selecting a first name, birthday, favourite animal, eye colour, etc. of a target child from a variety of menus affecting puppet's dialogue. Also different songs, rhymes, games and other activities can be customized. Finally the personalized program is downloaded to a computer equipped with an Internet connection and transferred into the puppet utilizing a standard parallel port of the computer.

However, some problems still remain unsolved with regard to the certain usability aspects of the mentioned solutions used in conjunction with an upgrade process of a target device. The need for a separate computer capable of connecting to the Internet for acquiring the personalized software or other optional data to be forwarded to the target device is annoying and sometimes even impossible depending on the current location of the user of the accessory device. Besides, the connection between the computer and said device is typically wired, resulting e.g. in unwanted cabling installation steps prior to the actual upgrade execution phase. In addition, methods related to the gathering of user information for the WWW (World Wide Web) based billing systems are often relatively awkward as the user is forced to type his personal data including name, address and credit card expiration date/number, to be authorized to download the preferred feature for said accessory device. For example, if the credit card information is not available or not remembered, the upgrade has to be delayed further in time. Sometimes product vendors and manufacturers decide to totally abandon the charging for web content due to “public opinion”. Internet based services are traditionally considered as cheap or completely free of charge and on the other hand, 100% secure Internet related transaction methods or universally recognized techniques for the transmission and enforcement of digital user rights are not very easy to be guaranteed. These facts may result a lower quality Internet/WWW services with ostensibly free “content” because at the same time there is a need to keep the operating costs of Internet sites minimal.

### SUMMARY OF THE INVENTION

The object of the present invention is to solve problems mentioned above. The invention discloses a method and an arrangement, preferably a wireless personal communications device such as a mobile terminal, for upgrading a target device. The invention provides a versatile but still a secure gateway for upgrading a target device which is connected to said terminal or other personal communications device at least for the upgrade execution. The invention is characterized by what is stated in the appended claims.

The term “target device” means here a device, for example an accessory device like PDA (Personal Digital Assistant) or a toy, which comprises data transmission means compatible for communication with a personal communications device. Devices which are not specially designed or tailored for use with a particular personal communications device can still be considered as target devices.

The term “upgrading” is also used in a wide sense in the text. Upgrading refers to a sort of personalization procedure wherein a memory content of a target device is somehow altered to better suit the user's purposes by downloading new data to the target device. For example, the results of an upgrade procedure may be realized as bug fixes or additional features including new programs/program parts, pictures, videos and playable sounds like MP3 music files. Upgrading can also be considered as a mere activation of an existing but locked functionality by transmitting an activation key from the service provider server to the target device via a personal communications device.

The term “installing” refers to all actions which are executed to the received upgrade data by the target device to enable the actual utilization of said data.

For many reasons, a modem mobile terminal equipped with additional software related to this particular invention, is a feasible platform for providing relatively affordable, portable, secure and comfortable means to upgrade a target device, which is connected to said terminal using existing, preferably wireless, data transmission capabilities of its own. Some high-tech products, both terminals and target devices, already have PAN (Personal Area Network) and LPRF (Low Power Radio Frequency) connectivity like BlueTooth in-built and naturally older IR (Infra-Red) or wire based solutions can be utilized as well. Generally speaking all telemetric data transmission methods such as simple inductive coupling between transmitter and receiver are exploitable.

Popular but limited SMS (Short Message Service) messages are still useful for transmitting upgrade/personalization requests and information but forthcoming MMS (Multimedia Messaging System) devices will provide a more complete support for delivering all common types of data including text, pictures, video and sound. WAP (Wireless Application Protocol) can be put to use as a bearer technology for MMS which probably guarantees wider industry support for the rapid adoption of MMS technology. On the other hand, traditionally relatively slow data connections between cellular networks and mobile terminals are history due to the advent of GPRS (General Packet Radio Service) networks and especially UMTS (Universal Mobile Telecommunications System) network architectures utilizing WCDMA (Wideband Code Division Multiple Access) techniques over an air interface, enabling high data transmission rates up to 2 Mbit/s. Another benefit of using a modem mobile terminal as an upgrade gateway arises from the fact that many personal communications device related security issues have not been addressed until recently. It is not just a question of an occasional data transmission security between the actual content provider and the terminal but a more comprehensive task of delivering digitally the rights to the user of a device, which rights determine the actions the user is allowed to proceed with the downloaded program/feature/data. DRM (Digital Rights Management) standardization is underway and consists of several sequential steps wherein different introduction levels (1-3) for DRM adaptation are defined. It is technically not sensible to implement DRM support to every possible target device as such, because according to the invention, DRM capabilities of the attached personal communications device may be utilized as well. Another important usability and security aspect relates to the different identification means like IMEI (International Mobile station Equipment Identity), SIM (Subscriber Identity Module), MMC (Multichip Module Circuit) etc., which are provided by a modem mobile terminal, enabling swift billing procedures for downloadable services, without separate need for typing user information during each upgrade session.

In one embodiment of the invention a mobile terminal is arranged to order a desired content file from a content provider server to be forwarded to a target device, said terminal arranged to receive a message including said content as a payload to be transferred to said target device, said terminal arranged to extract said payload from other data included in said message and to send said payload to said target device exploiting available, preferably wireless, connection means between said mobile terminal and said target device. Said received message may also include user rights information for downloaded encrypted content with an encryption key for decrypting the content. If that is the case, said terminal is arranged to decrypt the content of said message prior to forwarding it to said target device based on received user rights information.

In another embodiment of the invention the method described above includes an additional step wherein said target device initiates the upgrade process by sending the upgrade request to said mobile terminal.

In a further embodiment of the invention the payload of said message and the corresponding user rights are received separately in different files.

In a further embodiment of the invention said payload is an activation key for activating a feature included in the memory of said target device such as a toy.

In a further embodiment of the invention said payload includes personalized sounds to be reproduced in said target device, substantially a toy.

### BRIEF DESCRIPTION OF THE DRAWINGS

In the following, the invention is described in more detail by reference to the attached drawings, wherein

FIG. 1 shows a personal communications device and a target device connected by a wireless link;

FIG. 2 is a block diagram of a wireless personal communications device, substantially a mobile terminal, capable of acting as a gateway between a service provider and an accessory device;

FIG. 3 is a block diagram of a target device compatible for communication with a personal communications device;

FIG. 4 is a flow diagram disclosing a first embodiment of the invention;

FIG. 5 is a flow diagram disclosing a second embodiment of the invention;

FIG. 6A is a signalling diagram disclosing a second embodiment of the invention; and

FIG. 6B-6C visualize messages transmitted in a second embodiment of the invention.

### DETAILED DESCRIPTION

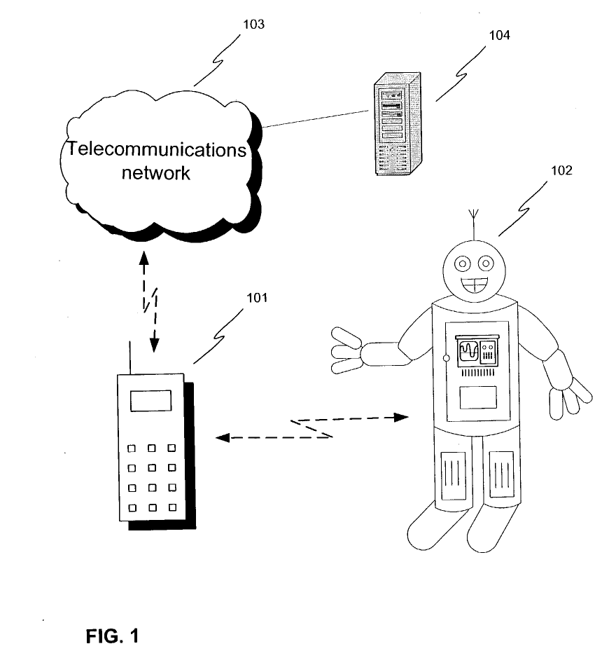

Referring to FIG. 1, the basic elements involved in the inventive concept are a wireless personal communications device 101, preferably a mobile terminal connected to a telecommunications network 103 providing access to a service provider server 104 directly or through a separate access network, and a target device 102, in this specific example, a toy robot. Said terminal 101 and target device 102 also include data transmission means of compatible type, which can vary moderately, thereby providing at least the minimum required properties for sending and receiving the information necessary for a successful upgrade data transmission between said devices 101, 102.

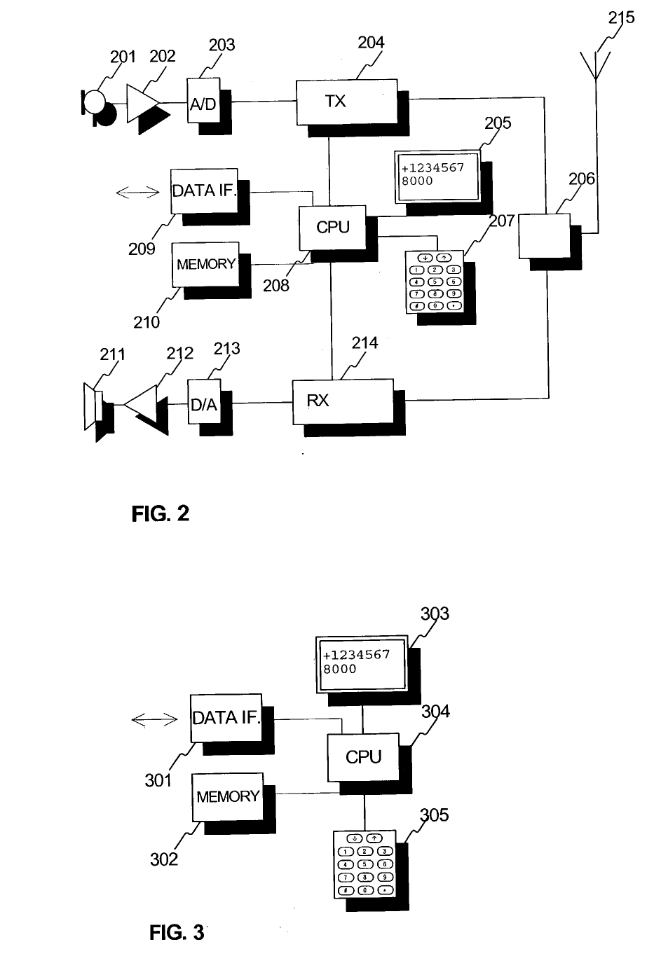

Referring to FIG. 2, the basic components of said wireless personal communications device capable of acting as an upgrade gateway for said target device are presented. Audio parts typically include a microphone 201, amplifiers 202, 212 and transducers 203, 213. Radio parts consist of TX/RX filters with a modulator/demodulator, an amplifier and an antenna necessary for transmitting and receiving the data over an air interface 204, 206, 214, 215. User interface 207 is needed for controlling the device and a display 205 for informing the user about current state and e.g. the memory contents of said device. Processing unit 208 controls the functionalities of said device and a memory 210 chip is needed for program/data storing purposes. A wireless data interface 209 enables connections to external devices. An essential power source/battery is not shown in the figure.

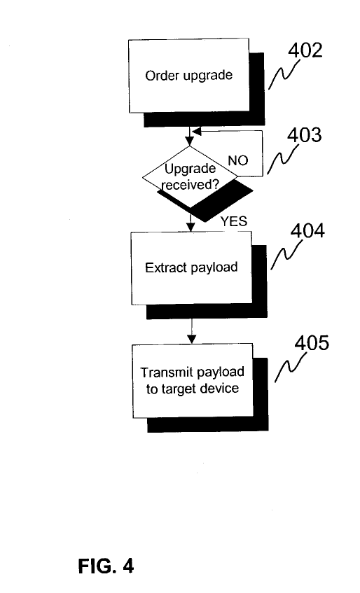

Referring to FIG. 3, a target device capable of communicating with a wireless personal communications device contains an interface for data transmission 301, a memory 302 for program/data storing and a processing unit 304 for internal controls and task execution. UI (User Interface) 305 and a display 303 are advantageous components when the upgrade process is manually initiated by e.g. pressing the button located in said target device.

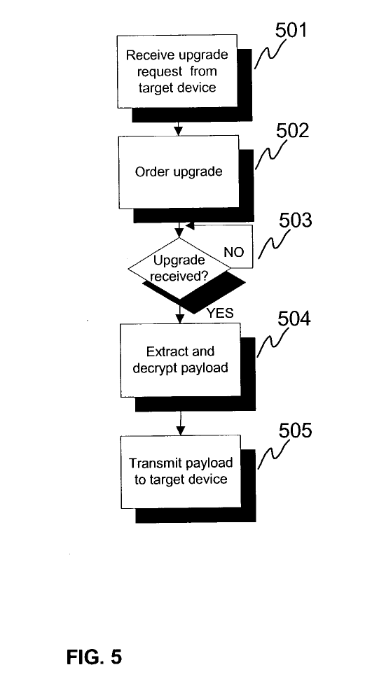

In the first embodiment of the invention, see the flowchart of FIG. 4, the involved target device is a MP3 player with embedded Bluetooth capability. MP3 players are often used in outdoor conditions, possibly while the user is jogging or having a walk etc., as conventional portable audio devices like C-cassette and CD players are quite sensitive to the obvious bumps and shocks resulting from the active movement the user is practising. This type of outdoor use seldom gives a relaxed opportunity of carrying e.g. a laptop computer, but today's small sized and light mobile terminals can easily be dragged along. This time the user has a mobile terminal, which supports also Bluetooth in addition to a conventional IR connection, with himself. The process is initiated by the user, who has decided to order a new hit song after having heard it on the radio. Next in phase 402 the user opens a connection to the server of commercial MP3 song supplier using the WAP browser of his cellular handset. The user sends a message containing an order which specifies at least the preferred song to be downloaded and possibly other optional data related e.g. to the urgency of the given order or data encapsulation format. Another more primitive ordering solution could utilize SMS messages including relevant ordering information sent to the related service provider number. Then the user switches said terminal to a standby mode until detecting an incoming data transmission related to the ordered MP3 song 403. After receiving the message said terminal detaches the desired MP3 file from other data 404. Finally said terminal transmits the song to said player device 405 utilizing Bluetooth as a connection type.

Additionally, the user may be requested to confirm the transmission of said upgrade to said player device by e.g. pressing a button via UI. Confirmation may also be required for establishing a connection between said terminal and said player device.

The received audio file is favourably included in a MMS message as an audio element, because service and content providers typically prefer to use as generic transmission formats as possible for delivering data to varying digital devices. MMS messaging is loosely based on SMS techniques so no logging on to a mail box etc. is needed and the network always stores the undeliverable messages for future delivery attempts at least a certain minimum period until deletion. As mentioned before, WAP standard nowadays includes a specific interface for transmitting MMS messages. MMS message headers may also be altered to contain new content types that indicate the specialized nature of the upgrade message to be sent to a target device or alternatively, the information needed for executing the upgrade may be included in the actual payload of the message relying on existing MMS standard, by providing necessary extra identification means like certain character strings for detecting the special purpose of received message.

If the content provider wants to limit the user rights for transmitted data, DRM scheme can be applied to said message. Forthcoming mobile DRM technology relies on twofold concept; actual content and the corresponding user rights are separated in MRCC (Mobile Rights Content Container) and MRV (Mobile Rights Voucher) objects. MRV expresses the rights which determine the actions the user can execute with downloaded data. Voucher acquisition between said terminal and the network server is handled by MRP (Mobile Rights Protocol). Voucher is also signed with the content provider's private key for verification of the sender party. The actual content is symmetrically encrypted using AES (Advanced Encryption Standard) and MRV logically includes CEK (Content Encryption Key) for content decryption. The internal objects of a MMS message may be encapsulated to one extended MIME (Multipurpose Internet Mail Extension, RFC2045, RFC2046, RFC2387, RFC2557) multipart message including both MRV and MRCC. Depending on the applied level of still unfinished DRM standard, voucher can also be delivered independently of the MRCC. Additionally, future DRM solutions will include asymmetric encryption of voucher data exploiting the terminal's public key. Naturally different identification means provided by a modem mobile terminal and mentioned above can be used for limiting the usage of a received service to a single terminal.

In addition to an optional DRM method, a more simple technique may be considered to the content usage. For example, UID (Unique ID) of a specific target device may be required to be transmitted to the content server to be used as a source for content encryption. Content server may then encrypt the upgrade data using etc. SC (Secret Code) associated with the particular UID, stored securely in the server as an UID/SC table for all delivered target device units. Only the device with a particular UID and SC can decode the data encrypted with the SC of its own.

When DRM or an equivalent rights management technique is applied to the presented method, said terminal is arranged to decrypt said content with the received code key prior to forwarding it to said target device. The user rights typically restrict the possible usage of said payload somehow; for example, the user may be allowed to forward the downloaded content only once or said content is exploitable, e.g. forwardable, for a limited time etc. Said terminal is arranged to comply with the received rules without exception.

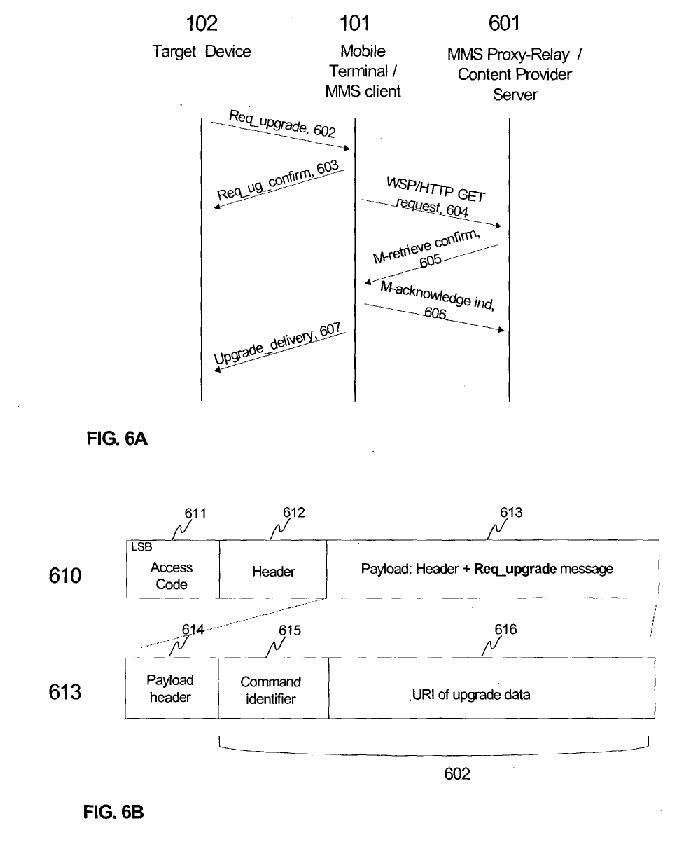

In the second embodiment of the invention, see the flowchart of FIG. 5, the upgrade process is initiated by said target device, for example, a toy robot, which is connected to said mobile terminal. In this embodiment, an “intelligent” toy robot contains an internal clock which notifies the operating system of said robot when the current installed software becomes outdated and needs an update, for example, after half years of use. Said robot also includes all necessary processing and memory capabilities for executing an software update, if connecting means for the data connection between said toy and the manufacturer server are provided for receiving the necessary upgrade data. This time both the robot and the terminal support wireless Bluetooth connections so data transmission means are compatible. Said terminal receives a message from said robot specifying at least the preferred service or data to be downloaded/updated and vital information about desired content provider connection for proper accessing of the content provider server 501. The manufacturer is naturally responsible for the permanency of the network addresses originally stored in the robot for future upgrade operations. The robot may also contain several different addresses for separate upgrade servers to guarantee the reliability of the upgrade method in overall. Said terminal sends a data request to the manufacturer server based on received contact information, see phase 502, and retrieves a message including said, possibly encrypted, upgrade data in phase 503. Said terminal optionally decrypts said data by utilizing e.g. DRM techniques 504 prior to forwarding 505 it to said robot by exploiting existing Bluetooth connection. The robot further decrypts the received data if required and installs said data in a free or otherwise suitable memory location for future use. If the connection between said robot and said terminal has been lost before task completion, the terminal may store the received message including upgrade information for later retransmission.

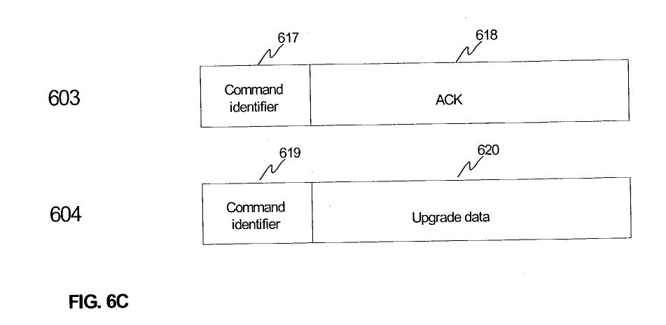

One possibility to carry out the messaging for the embodiment described above is illustrated in FIGS. 6A, 6B and 6C. Note that messages introduced in the figure may belong to different network layers but they all are logically bound to each other for completing the upgrade task. A target device 102 supports Bluetooth for wireless data transmission and implements mandatory radio, link control and link management/support unit functionalities described in the Bluetooth Specification 1.1 by Bluetooth SIG, Inc. A mobile terminal 101 complies with WAP and MMS standards in addition to Bluetooth. First, the target device 102 initiates an upgrade process by sending a message Req_upgrade 602 containing an upgrade request to the mobile terminal 101 utilizing an established Bluetooth link. Bluetooth links SCO (Synchronous Connection-Oriented) and ACL (Asynchronous Connection-Less) can be set up by exploiting standardized inquiry and paging procedures but they are not in the scope of this invention and thus not described here more deeply. Req_upgrade message 602 is embedded in the Bluetooth packet of preferred type sent via, for example, ACL link between the target device 102 and the terminal 101. Standard Bluetooth packet 610 is presented in the figure and it consists of three fields: access code 611, header 612 and payload 613, all of them including various segments. Access code 611 is used for synchronization purposes, DC offset compensation and identification while header 612 includes LC (Link Control) segments for packet type definition, packet numbering scheme and flow control mode. In addition, payload 613 includes payload header 614, which e.g. informs the receiving end about applied payload length (0-2745 bits) being dependent of the packet type. Req_upgrade 602 contains fields needed in informing the terminal 101 how to acquire the required upgrade data through the network. At least, the destination URI (Uniform Resource Identifier) 616 of the MMS message including upgrade data should be described comprehensively. Upgrade request message is recognised by the terminal 101 from Command_identifier 615. Additionally, the identifier 615 defines the exact type of the requested upgrade data. Of course, an additional field can be specially designed for guiding the forthcoming data extraction phase, however that is not the case in this example. The terminal 101 acknowledges the request by sending a confirmation message Req_ug_confirm 603 including identification 617 and data fields 618 back to the target device 102 and then transmits a MMS message request to the MMS Proxy-Relay 601 utilizing one of the standard WAP services, WSP (Wireless Session Protocol)/ HTTP (HyperText Transfer Protocol) functionality GET 604. Usually the application located in the terminal and capable of handling MMS transactions is called a MMS client. Next, the proxy replies with a standard M-retrieve.conf 605 message containing necessary header fields and the requested upgrade data as a message body. The terminal sends a corresponding acknowledgement M-acknowledge ind 606 to the proxy. M-acknowledge ind 606 comprises only header info like most of the MMS messaging PDU's (Protocol Data Unit). Upgrade data is extracted from the message utilizing the information included in Command_identifier 615 and forwarded to the target device 102 via existing Bluetooth link in Upgrade_delivery 607 message, which consists of separate identification 619 and data fields 620. Described method doesn't include any billing or DRM procedures but they can be conveniently added to the existing operational structure if preferred. Applied MMS transactions M-retrieve.conf 605 and M-acknowledge ind 606 are specified in the WAP MMS Encapsulation Protocol document by WAP Forum.

In a further embodiment of the invention, content that the user has ordered and the user rights for constricted exploitation of said content are received in two separate messages. For example, the levels 2-3 of DRM standard to be published allow distributed transmission of MRCC and MRV. The terminal 101 is arranged to wait for the reception of MRV prior executing the decryption and forwarding of MRCC.

In a further embodiment of the invention, said payload of said message includes activation data for activating a locked feature included in the memory of said target device 102 such as a toy. Toys are usually preferred to be affordable and the amount of rather expensive non-volatile memory is tried to be kept to a minimum. If all possible features which said toy is supposed to perform during its lifetime can be included in the memory as a part of the toy's manufacturing phase, they can be simply locked and activated later by activation data, commonly called as an “activation key” or “activation code”. To the average user of e.g. a toy, the difference between an activated feature and a corresponding, possibly slightly personalized, downloaded feature is often non-existent. Of course, if preferred personalization goals are not satisfyingly met with a proposed activation method, it can be combined with a conventional download-based upgrade approach. The amount of data required for transmitting an activation key is typically negligible compared to said download-based approach.

In a further embodiment of the invention said payload includes personalized sounds to be used in said target device 102, preferably a toy. User defines in the order to be transmitted the personalization parameters of said sound, which affect e.g. to voice type, content and playing time of said sound. At the server side, the personalization can be accomplished by prerecording the most popular sound variants and allowing a selection from them and/or by utilizing a speech synthesis technique for totally free selection of sounds. The order could be of the following type: “SOUND GOOD MORNING 0800 TEDDY MIKKO” wherein SOUND refers to a downloadable sound, GOOD MORNING indicates the preferred sentence personalized to MIKKO to be played at 08.00 using a TEDDY voice. The server can primarily apply pre-recorded samples for producing the desired output and then complete the missing words with synthesized counterparts or create the sentence using a synthesizer straight from the beginning. The action finally executed by a toy could be a playback of sentence “Good morning Mikko! Did you sleep well?” spoken in teddy-bear voice at 8 am. The protocol specifying the methods for the personalization of toy sounds is simple to design over existing presented messaging interfaces for one skilled in the art.

Modern lifestyle creates more and more demand for executing varying tasks with digital devices on the move and described terminals are capable of carrying out such wishes with a help of the presented method. At the same time, service and content providers can benefit from the billing, rights management and security options, which are all provided by a mobile terminal now or in the near future. According to the invention, a modern personal communications device such as a mobile terminal can be cleverly utilized for upgrading a target device connected to said terminal via a wireless link.

The invention is not limited to the embodiments described above; the scope of the invention can be discovered in the following independent claims. In addition to a toy, target device can be a car, a microwave oven, a coffee maker, a PDA or practically any kind of device comprising data transmission means for communication with a wireless personal communications device. Transmission means may exploit radio frequencies, IR, acoustic waves, telemetric techniques in general etc. A wireless personal communications device may be, for example, a mobile terminal or an advanced PDA.

1. A method for upgrading a target device, where the upgrading is to be performed by a wireless personal communications device operable in a telecommunications network, wherein said wireless personal communications device and said target device are enabled to communicate with each other, characterized in that said method comprises the steps of
ordering the upgrade data for said target device from a content provider server (402),
receiving in said wireless personal communications device a message from said content provider server including said ordered upgrade data as a payload of said message (403),
extracting said payload from said message (404), and
transmitting said payload to said target device (405).

2. A method of claim 1, characterized wherein said method further comprises a step of establishing a connection between said wireless personal communications device and said target device.

3. A method of claim 1, characterized wherein said method further comprises a step of receiving said upgrade order from said target device, exploiting an established wireless data connection between said wireless personal communications device and said target device.

4. A method of claim 1, characterized wherein said method further comprises a step of confirming from the user if said transmission to said target device is to be executed.

5. A method of claim 1, characterized wherein said method further comprises a step of confirming from the user if said connection with said target device is to be established.

6. A method of claim 1, characterized wherein said message received from content provider is substantially a MMS (Multimedia Messaging System) or SMS (Short Message Service) message.

7. A method of claim 1, characterized wherein the header of said message received from content provider comprises at least one field that instructs said wireless personal communications device to forward said payload to said target device.

8. A method of claim 1, characterized wherein said message comprises at least one specific data pattern that instructs said wireless personal communications device to forward said payload to said target device.

9. A method of claim 1, characterized wherein said order is substantially a SMS or MMS message.

10. A method of claim 1, characterized wherein said received message comprises encrypted payload.

11. A method of claim 10, characterized wherein the method further includes a step of decrypting said payload with a received additional data enabling the decryption.

12. A method of claim 1, characterized wherein said received message comprises the user rights for said payload, for defining the allowed usage of said payload.

13. A method of claim 12, characterized wherein said received message comprises DRM (Digital Rights Management) protected payload included in the DRCC (Digital Rights Content Container) with user rights determined in the DRV (Digital Rights Voucher), received with said DRCC in said message, for defining the allowed usage of said payload.

14. A method of claim 1, characterized wherein said method further comprises a step of receiving another message comprising the user rights for said payload, for defining the allowed usage of said payload.

15. A method of claim 14, characterized wherein said received message comprises DRM protected payload included in the DRCC, with user rights determined in the DRV, received in two separate messages, for defining the allowed usage of said payload.

16. A method of claim 1, characterized wherein said payload comprises activation data to be used for enabling the utilization of a feature in said target device, which feature has been excluded from the use until activation.

17. A method of claim 16, characterized wherein said activation data contains an activation code to be compared with another code stored in said target device (102) for activating said feature when said two codes match.

18. A method of claim 16, characterized wherein said activation data contains an activation code to be used as a source for a procedure to be performed in said target device (102), the positive result of which activates said feature.

19. A method of claim 1, characterized wherein said order comprises personalization parameters for personalized sounds to be reproduced by said target device, substantially a toy.

20. A method of claim 19, characterized wherein said received payload comprises personalized sounds to be reproduced by said target device, substantially a toy.

21. A wireless personal communications device (101) capable of wireless communication over an air interface (204,206,214,215) via a telecommunications network (103), said wireless personal communications device (101) comprising data transmission means for wireless data connection (209) between said wireless personal communications device (101) and a target device (102), said wireless personal communications device (101) comprising processing means (208) and memory means (210) for processing and storing instructions and data, characterized in that said wireless personal communications device (101) is arranged to order the upgrade data for said target device (102) from the content provider server (104), arranged to receive a message from said content provider comprising said ordered upgrade data as a payload of said message, arranged to extract said payload from said message, and arranged to transmit said payload to said target device exploiting said transmission means (209).

22. A wireless personal communications device of claim 21, characterized in that it is arranged to establish a connection between said wireless personal communications device (101) and said target device (102).

23. A wireless personal communications device of claim 21, characterized in that it is substantially a GSM (Global System for Mobile communications) or UMTS (Universal Mobile Telecommunication System) terminal.

24. A wireless personal communications device of claim 21, characterized in that said transmission means (209) are substantially telemetric.

25. A wireless personal communications device of claim 21, characterized in that said transmission means (209) utilize LPRF (Low Power Radio Frequency) techniques.

26. A wireless personal communications device of claim 25, characterized in that said transmission means (209) use Bluetooth as a transmission protocol.

27. A wireless personal communications device of claim 21, characterized in that it is arranged to decrypt said payload with other received data enabling the decryption.

28. A wireless personal communications device of claim 21, characterized in that it is arranged to decrypt said payload with at least one separate identification mean unique to said wireless personal communications device (101) or to the user of said device.

29. A wireless personal communications device of claim 21, characterized in that it is arranged to search in the received message for at least one predetermined identification mean which identifies said payload as to be transmitted to said target device (102).

30. A wireless personal communications device of claim 21, characterized in that it is arranged to decrypt and forward DRM encrypted payload located in the DRCC of said received message, based on received user rights information located in the DRV.

31. A wireless personal communications device of claim 21, characterized in that it is arranged to send said order substantially as a SMS or MMS message.

32. A wireless personal communications device of claim 21, characterized in that it is arranged to receive said payload encapsulated substantially as a SMS or MMS message.

33. A target device (102) capable of wireless communication with a wireless personal communications device (101) being capable of wireless communication over an air interface (204, 206, 214, 215) via a telecommunications network (103), said target device (102) comprising processing means (304) and memory means (302) for processing and storing instructions and data, characterized in order to upgrade data for said target device (102) from a content provider server (104) via said wireless personal communications device (101), said target device (102) is arranged to receive the upgrade data from said wireless personal communications device (101) and arranged to install said upgrade data for exploitation.

34. A target device (102) of claim 33, characterized in that it is arranged to send an upgrade request to said wireless personal communications device (101).

35. A target device of claim 33, characterized in that it is substantially a toy.

36. A target device of claim 33, characterized in that it is arranged to establish a connection to said wireless personal communications device (101) prior sending said order.

37. A target device of claim 33, characterized in that it is arranged to include a resource locator in said order for acquiring the upgrade data from the content provider server, the network location of which determined by said resource locator.
